(19) United States
(12) Patent Application Publication
(10) Pub. No.: US 2013/0130618 A1
(43) Pub. Date: May 23, 2013

(54) SYSTEM AND METHOD FOR INTEGRALLY COLLECTING RAINFALL ATTENUATION AND RAINFALL INTENSITY DATA IN SATELLITE SYSTEM

(71) Applicant: Electronics and Telecommunications Research In, Daejeon (KR)

(72) Inventors: Kyung Soo CHOI, Daejeon (KR); Jae Hoon KIM, Daejeon (KR); Do Seob AHN, Daejeon (KR)

(73) Assignee: Electronics and Telecommunications Research Institute, Daejeon (KR)

(21) Appl. No.: 13/683,580

(22) Filed: Nov. 21, 2012

(30) Foreign Application Priority Data
Nov. 21, 2011 (KR) 10-2011-0121398

(51) Int. Cl. H04B 17/02

(52) U.S. Cl. CPC H04B 17/02
USPC 455/9

(57) ABSTRACT

A system and method for observing a wireless frequency in a space between planets is provided. A system for integrally collecting rainfall intensity and rainfall attenuation data may include a remote measuring apparatus to measure an amount of a rainfall attenuation of a satellite signal based on a rainfall intensity at a predetermined point, to generate rainfall intensity and rainfall attenuation data based on the amount of the rainfall attenuation measured, and to transmit the generated rainfall intensity and rainfall attenuation data to a satellite relay, and an integrated center system to collect the generated rainfall intensity and rainfall attenuation data from the satellite relay.

### CROSS-REFERENCE TO RELATED APPLICATION

This application claims the benefit of Korean Patent Application No. 10-2011-0121398, filed on Nov. 21, 2011, in the Korean Intellectual Property Office, the disclosure of which is incorporated herein by reference.

### BACKGROUND

1. Field of the Invention

The present invention relates to a method and apparatus for integrally collecting rainfall intensity data and an amount of attenuation of a satellite signal caused by a rainfall in a satellite communication system, and more particularly, to a method and apparatus that may automatically measure a receiving intensity of a satellite signal corresponding to a rainfall intensity, and the rainfall intensity essentially used for rainfall attenuation model development in the satellite communication system, and may integrally collect a plurality of data scattered throughout the whole country, using a satellite link.

2. Description of the Related Art

According to a conventional technology, in order to verify a degree of attenuation of a received signal depending on an amount of rainfall, there is provided an apparatus for verifying the degree of signal attenuation depending on the amount of rainfall that may initialize rainfall amount recorder and signal quality measuring devices, control the rainfall amount recorder and the signal quality measuring device when a plurality of timers are triggered by driving the plurality of timers based on a time parameter, and verify reliability by individually storing and collecting rainfall amount data, carrier-to-noise ratio data, and signal-to-noise ratio data in an auxiliary memory, for example, a universal serial bus (USB) memory.

However, since a wireless communication system is targeted in the conventional technology, a valid path length at which rainfall attenuation occurs is not considered. For example, in a case of a satellite system operating in a geostationary orbit at an altitude of 36,000 kilometers (km) and directly above the Equator, data of a plurality of regions may be collected by an individual storage device via a ground Internet network at a ground receiving point of a satellite signal, however, such data collection may be performed manually in a region in which the Internet network is unavailable.

In addition, in a case of an automated measuring system which is installed and operated in a distant mountain region, a separate system for monitoring system state information in real time may be needed.

### SUMMARY

According to an aspect of the present invention, there is provided a system for integrally collecting rainfall intensity and rainfall attenuation data, the system including a remote measuring apparatus to measure an amount of a rainfall attenuation of a satellite signal based on a rainfall intensity at a predetermined point, to generate rainfall intensity and rainfall attenuation data based on the amount of the rainfall attenuation measured, and to transmit the generated rainfall intensity and rainfall attenuation data to a satellite relay, and an integrated center system to collect the generated rainfall intensity and rainfall attenuation data from the satellite relay.

According to another aspect of the present invention, there is also provided a method of integrally collecting rainfall intensity and rainfall attenuation data, the method including measuring a rainfall intensity, and an amount of a rainfall attenuation in which a receiving intensity of a satellite signal corresponding to the rainfall intensity is reflected, using a separate measuring device at a predetermined point, generating rainfall intensity and rainfall attenuation data based on the measured rainfall intensity, and the amount of the rainfall attenuation measured, transmitting the generated rainfall intensity and rainfall attenuation data to a satellite relay, and collecting the generated rainfall intensity and rainfall attenuation data from the satellite relay.

According to an embodiment of the present invention, when rainfall attenuation and rainfall intensity measuring devices are installed and operated in a plurality of regions, data measured by each remote measuring system may be integrally collected and processed in real time, irrespective of a distance and local circumstances.

According to an embodiment of the present invention, a system for establishing satellite communication network facilities that may monitor, in real time, state information of a remote device operating in an unmanned manner may be provided.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system of integrally collecting rainfall intensity and rainfall attenuation data according to an embodiment of the present invention;

FIG. 2 is a block diagram illustrating a remote measuring apparatus according to an embodiment of the present invention;

FIG. 3 is a block diagram illustrating an integrated center system according to an embodiment of the present invention;

FIGS. 4 and 5 are flowcharts illustrating a method of integrally collecting rainfall intensity and rainfall attenuation data according to an embodiment of the present invention;

FIG. 6 is a diagram illustrating a format of a signal to be transferred from a remote measuring apparatus to an integrated center system via a satellite relay according to an embodiment of the present invention; and

FIG. 7 is a diagram illustrating a format of a signal to be transferred from an integrated center system to a remote measuring apparatus via a satellite relay according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined that a detailed description is related to a related known function or configuration which may make the purpose of the present invention unnecessarily ambiguous in the description of the present invention, such detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

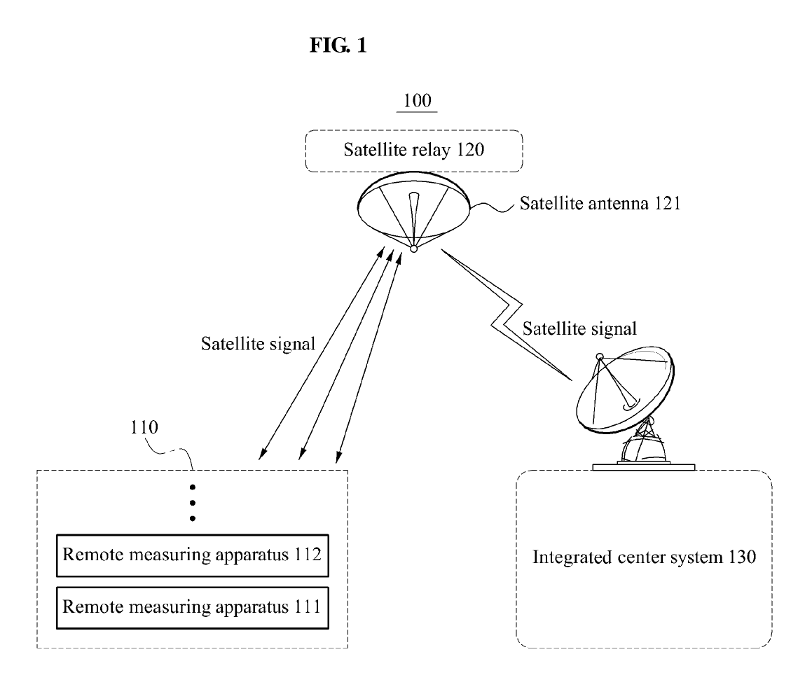

FIG. 1 is a diagram illustrating a system 100 of integrally collecting rainfall intensity and rainfall attenuation data according to an embodiment of the present invention.

Referring to FIG. 1, the system 100 may include at least one remote measuring apparatus 110, a satellite relay 120, and an integrated center system 130. Here, the at least one remote measuring apparatus 110 may be positioned in at least one point.

The system 100 may provide a technical concept on satellite integrated collection of an amount of attenuation of a satellite signal caused by a rainfall and rainfall intensity data.

In particular, the system 100 may automatically measure, using a separate measuring device, a receiving intensity of a satellite signal corresponding to a rainfall intensity, and the rainfall intensity that is essentially used for rainfall attenuation model development in a satellite communication system, and may integrally collect a plurality of data scattered throughout an entire country in which a great amount of rainfall intensity is present, using a satellite link.

To achieve the foregoing, the system 100 may include the at least one remote measuring apparatus 110, for example, remote measuring apparatuses 111 and 112, that may be installed at main points throughout the entire country in which a great amount of rainfall intensity is present to measure an amount of rainfall attenuation of a satellite signal depending on a rainfall intensity of a corresponding point.

The system 100 may further include the satellite relay 120 that may transmit rainfall intensity and rainfall attenuation data to an integrated center.

In addition, the system 100 may further include the integrated center system 130 to receive, via the satellite relay 120, all types of data transmitted from the at least one remote measuring apparatus 110.

The integrated center system 130 may quickly report an emergency situation to a predetermined user, as necessary, in response to all types of measured data that is transmitted from the at least one remote measuring apparatus 110. For example, the integrated center system 130 may report the emergency situation using a short message service (SMS).

The satellite relay 120 may perform a long distance information relay function between ground devices, and may include a satellite antenna 121 for telecommunication between the ground devices. In addition, although not shown in FIG. 1, the satellite relay 120 may internally include a satellite receiver, a frequency converter, and a satellite transmitter.

The satellite antenna 121 may receive an uplink signal transmitted from a satellite terminal antenna (not shown) of the remote measuring apparatuses 111 and 112 that are disposed on the ground, transmit the received uplink signal to the satellite receiver, and transmit a downlink signal transmitted from the satellite transmitter to a satellite hub antenna (not shown) of the integrated center system 130.

The satellite receiver may perform low-noise amplification on a signal in a predetermined band, among signals received via the satellite antenna 121, and the frequency converter may convert the low-noise amplified signal into a signal in an intermediate frequency band.

The satellite transmitter may adjust a gain to be at a predetermined level after converting the signal in the intermediate frequency band into a downlink signal, and may transfer the downlink signal to the satellite antenna 121 by amplifying the downlink signal to be a size required for establishing a downlink.

In order to develop a rainfall attenuation model for regions having a significant amount of regional torrential rain, similar to South Korea, data measured from as many regions as possible is to be collected.

When measuring systems are installed in a plurality of regions to individually collect rainfall intensity data and rainfall attenuation amount data depending on an amount of a rainfall, and to process the collected data manually, a great deal of manpower and time may be required. However, according to an embodiment of the present invention, information may be collected and processed in real time using the system 100.

In addition, according to an embodiment of the present invention, the system 100 may enable a remote control by an operator by establishing and operating a communication network.

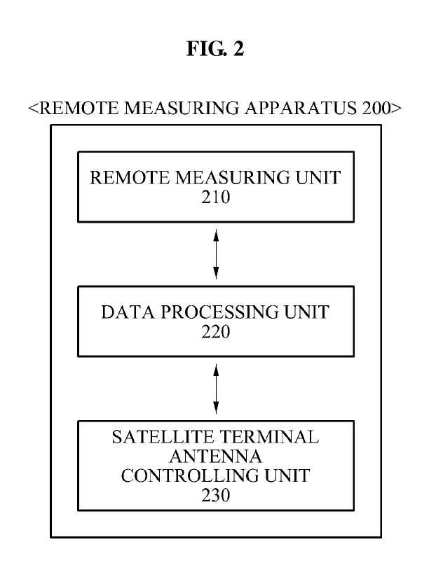

FIG. 2 is a block diagram illustrating a remote measuring apparatus 200 according to an embodiment of the present invention.

Referring to FIG. 2, the remote measuring apparatus 200 may include a remote measuring unit 210, a data processing unit 220, and a satellite terminal antenna controlling unit 230.

The remote measuring unit 210 may generate rainfall intensity and rainfall attenuation data, by measuring a level of rainfall intensity, and an amount of rainfall attenuation in which a receiving intensity of a satellite signal corresponding to the rainfall intensity is reflected, using a separate measuring device at a predetermined point.

The data processing unit 220 may preprocess the generated rainfall intensity and rainfall attenuation data in order to transmit the generated rainfall intensity and rainfall attenuation data to an integrated center (not shown).

That is, the data processing unit 220 may store the generated rainfall intensity and rainfall attenuation data internally, and may perform the preprocessing to convert the generated rainfall intensity and rainfall attenuation data into a satellite signal.

The satellite terminal antenna controlling unit 230 may transmit the preprocessed rainfall intensity and rainfall attenuation data to a satellite relay (not shown), by controlling a satellite terminal antenna (not shown).

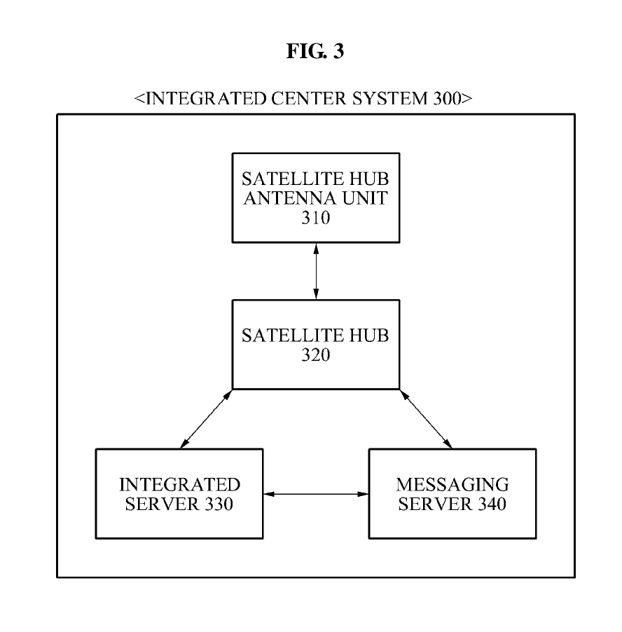

FIG. 3 is a block diagram illustrating an integrated center system 300 according to an embodiment of the present invention.

The integrated center system 300 may perform a function of integrally collecting data measured by a plurality of remote measuring apparatuses, via a satellite. The system 300 may include a satellite hub antenna unit 310, and a satellite hub 320.

The satellite hub antenna unit 310 may receive rainfall intensity and rainfall attenuation data from a satellite relay (not shown).

For example, the satellite hub antenna unit 310 may amplify the received rainfall intensity and rainfall attenuation data to a value greater than a predetermined threshold value. That is, the satellite hub antenna unit 310 may amplify a weak satellite signal received via the satellite relay, and may transfer the amplified satellite signal to the satellite hub 320.

The satellite hub 320 may convert the received rainfall intensity and rainfall attenuation data into a ground signal. For example, the satellite hub 320 may convert the received rainfall intensity and rainfall attenuation data into original digital data.

The integrated center system 300 may further include an integrated server 330 to store the rainfall intensity and rainfall attenuation data converted into the ground signal, and to analyze the stored rainfall intensity and rainfall attenuation data.

The integrated center system 300 may further include a messaging server 340 to transmit, to a predetermined communication terminal, a message corresponding to a result of analyzing the rainfall intensity and rainfall attenuation data.

For example, the messaging server 340 may be included in the integrated server 330 to report in real time, to a predetermined operator, contents of an error according to an error type, in a form of a text message, when the error occurs in equipment of an integrated center and a remote measuring apparatus operating in an automated manner.

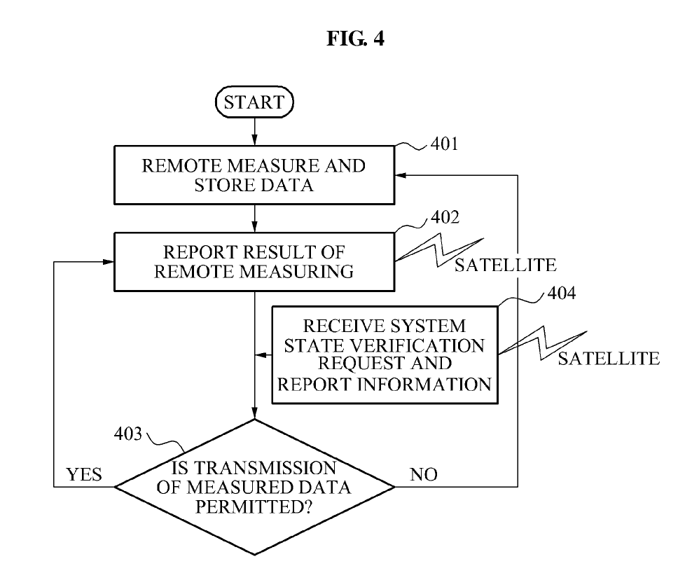

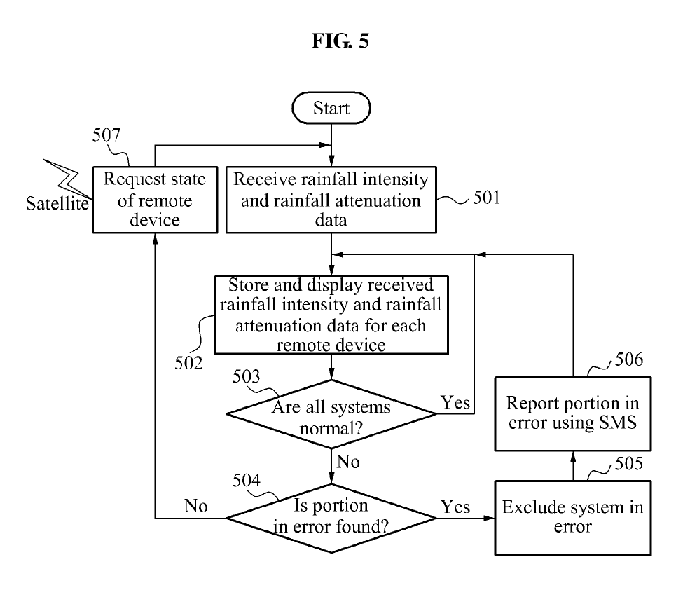

FIGS. 4 and 5 are flowcharts illustrating a method of integrally collecting rainfall intensity and rainfall attenuation data according to an embodiment of the present invention.

FIG. 4 is a flowchart illustrating an operating method of at least one remote measuring apparatus in a system of integrally collecting rainfall intensity and rainfall attenuation data according to an embodiment of the present invention.

Referring to FIG. 4, in operation 401, a rainfall intensity, and an amount of a rainfall attenuation in which a receiving intensity of a satellite signal corresponding to the rainfall intensity is reflected may be measured using a separate measuring device at a predetermined point. Rainfall intensity and rainfall attenuation data may be generated based on the measured rainfall intensity and the amount of the rainfall attenuation measured. The generated rainfall intensity and rainfall attenuation data may be stored.

In operation 402, by transmitting the generated rainfall intensity and rainfall attenuation data to a satellite relay, a result of remote measurement may be reported to an integrated center system.

That is, rainfall intensity and rainfall attenuation data that is automatically measured at predetermined intervals may be stored in an internal storage device, and report data may be satellite-packetized using an assigned Internet Protocol (IP) address and transmitted to the satellite relay in order to initially report the stored rainfall intensity and rainfall attenuation data.

The data transmitted to the satellite relay may be transferred to a satellite hub in the future.

Subsequent data may be stored internally, and the integrated center system may determine whether additional transmission of the data is permitted in operation 403. When the additional transmission of the data is permitted, the method returns to operation 402 to request periodical transmission of the data.

When the additional transmission of the data is not permitted, the method returns to operation 401 to maintain an internal storage state until the transmission of the data is permitted.

In operation 404, when the at least one remote measuring apparatus receives a request for system state verification from the integrated center system, information about the system state may be reported to the integrated center system, by transmitting a response message to the integrated center system via a satellite terminal antenna, in response to the corresponding request.

FIG. 5 is a flowchart illustrating an operating method of an integrated center system in a system of integrally collecting rainfall intensity and rainfall attenuation data according to an embodiment of the present invention.

In the method of FIG. 5 according to an embodiment of the present invention, generated rainfall intensity and rainfall attenuation data may be collected.

In particular, in operation 501, the rainfall intensity and rainfall attenuation data may be received from at least one remote measuring apparatus via a satellite replay.

In operation 502, the received rainfall intensity and rainfall attenuation data may be managed, for example, stored in a data base and displayed, for each of the at least one remote measuring apparatus.

In operation 503, whether states of all of the at least one remote measuring apparatus and an internal apparatus are normal may be verified. When the states are abnormal, whether a portion in error is present may be re-verified in operation 504. When the portion in error is not found, the states of the at least one remote measuring apparatus may be requested from the at least one remote measuring apparatus, in operation 507.

When the portion in error is found, the portion in error may be excluded from the operation, in operation 505. In operation 506, the portion in error may be reported to an operator through an SMS server.

According to an embodiment of the present invention, when rainfall attenuation and rainfall intensity measuring devices are installed and operated in a plurality of regions, data measured by each of the at least one remote measuring system may be integrally collected and processed in real time, irrespective of a distance and local circumstances.

According to an embodiment of the present invention, a system for establishing satellite communication network facilities that may monitor, in real time, state information of a remote device operating in an unmanned manner may be provided.

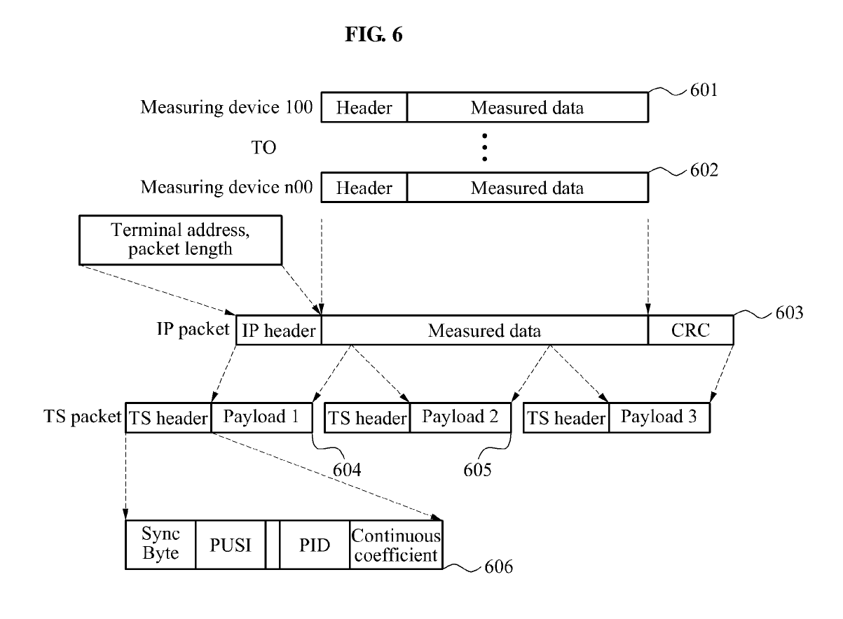

FIG. 6 is a diagram illustrating a format of a signal to be transferred from a remote measuring apparatus to an integrated center system via a satellite relay according to an embodiment of the present invention.

Data packets 601 and 602 that may be transmitted from the remote measuring apparatus to a data processing unit may include a header indicating an ID of the remote measuring device, and measured data.

An IP packet 603 may refer to a satellite packet to be transferred from the data processing unit to a satellite hub, via a satellite relay. The IP packet 603 may include an IP header of the data processing device, and a cyclic redundancy check (CRC) for error control, in an application data frame of measured data packet.

A satellite signal that is generated and transmitted from the data processing unit to the satellite relay may correspond to a transport stream (TS) packet 604 or 605. The data processing unit may generate a plurality of payload frames by segmenting the IP packet 603 in an identical length, and may assign payload numbers to the plurality of payload frames, sequentially.

In addition, the data processing unit may generate a plurality of TS packets by adding TS headers to front ends of all the plurality of payload frames to which the payload numbers are assigned, respectively.

The TS header 606 may include a synchronization byte (Sync Byte) indicating a start of a packet frame, a payload unit start indicator (PUSI) indicating whether the payload started, a packet identifier (PID) used for recognizing a TS packet, a continuous coefficient indicating whether a plurality of TS packets is terminated, and the like. The data segmented in the identical length by a satellite terminal may be combined into complete information in a satellite hub.

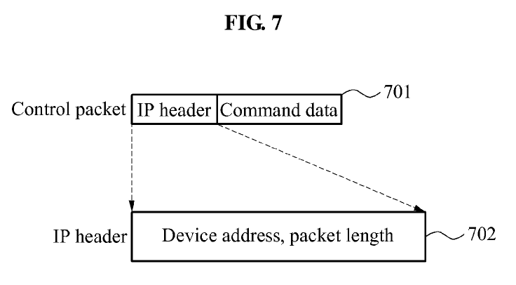

FIG. 7 is a diagram illustrating a format of a signal to be transferred from an integrated center system to a remote measuring apparatus via a satellite relay according to an embodiment of the present invention.

Referring to FIG. 7, a control packet 701 may include a header 702, for example, an IP header, and command data. The header 702 may include a measuring device address, a packet length, and the like. Although not shown in FIG. 7, the command data may include information indicating a plurality of internal modules included in the remote measuring apparatus.

An operating program for which an individual log-in and remote control are possible may be installed in an integrated server, and measured information may be searched for at any location through a satellite communication network.

When a system and method for integrally collecting rainfall intensity and rainfall attenuation data is used, an integrated center may measure an amount of attenuation of a receiving signal depending on a rainfall intensity, using computers disposed in a plurality of regions in order to develop a rainfall attenuation model of a country or a predetermined region, and may collect and store the data measured by the computers installed in the plurality of regions, via a satellite, whereby loss of the data may be prevented in advance, to when compared to a ground network.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for integrally collecting rainfall intensity and rainfall attenuation data, the system comprising:
a remote measuring apparatus to measure an amount of a rainfall attenuation of a satellite signal based on a rainfall intensity at a predetermined point, to generate rainfall intensity and rainfall attenuation data based on the amount of the rainfall attenuation measured, and to transmit the generated rainfall intensity and rainfall attenuation data to a satellite relay; and
an integrated center system to collect the generated rainfall intensity and rainfall attenuation data from the satellite relay.

2. The system of claim 1, wherein the remote measuring apparatus comprises:
a remote measuring unit to generate rainfall intensity and rainfall attenuation data, by measuring a rainfall intensity, and an amount of a rainfall attenuation in which a receiving intensity of a satellite signal corresponding to the rainfall intensity is reflected, using a separate measuring device at a predetermined point;
a data processing unit to preprocess the generated rainfall intensity and rainfall attenuation data in order to transmit the generated rainfall intensity and rainfall attenuation data to an integrated center; and
a satellite terminal antenna controlling unit to transmit the preprocessed rainfall intensity and rainfall attenuation data to the satellite relay, by controlling a satellite terminal antenna.

3. The system of claim 1, wherein the integrated center system comprises:
a satellite hub antenna unit to receive the rainfall intensity and rainfall attenuation data from the satellite relay; and
a satellite hub to convert the received rainfall intensity and rainfall attenuation data into a ground signal.

4. The system of claim 3, wherein the satellite hub antenna unit amplifies the received rainfall intensity and rainfall attenuation data to a value greater than a predetermined threshold value.

5. The system of claim 3, wherein the integrated center system further comprises:
an integrated server to store the rainfall intensity and rainfall attenuation data converted into the ground signal, and to analyze the stored rainfall intensity and rainfall attenuation data.

6. The system of claim 5, wherein the integrated center system further comprises:
a messaging server to transmit, to a predetermined communication terminal, a message corresponding to a result of analyzing the rainfall intensity and rainfall attenuation data.

7. A method of integrally collecting rainfall intensity and rainfall attenuation data, the method comprising:
measuring a rainfall intensity, and an amount of a rainfall attenuation in which a receiving intensity of a satellite signal corresponding to the rainfall intensity is reflected, using a separate measuring device at a predetermined point;
generating rainfall intensity and rainfall attenuation data based on the measured rainfall intensity, and the amount of the rainfall attenuation measured;
transmitting the generated rainfall intensity and rainfall attenuation data to a satellite relay; and
collecting the generated rainfall intensity and rainfall attenuation data from the satellite relay.

8. The method of claim 7, wherein the transmitting comprises:
preprocessing the generated rainfall intensity and rainfall attenuation data in order to transmit the generated rainfall intensity and rainfall attenuation data to an integrated center; and
transmitting the preprocessed rainfall intensity and rainfall attenuation data to the satellite relay, by controlling a satellite terminal antenna.

9. The method of claim 7, further comprising:
converting the collected rainfall intensity and rainfall attenuation data into a ground signal.

10. The method of claim 9, further comprises:
storing the rainfall intensity and rainfall attenuation data converted into the ground signal, and analyzing the stored rainfall intensity and rainfall attenuation data; and
transmitting, to a predetermined communication terminal, a message corresponding to a result of analyzing the rainfall intensity and rainfall attenuation data.
